(19) United States
(12) Patent Application Publication
(10) Pub. No.: US 2026/0227569 A1
(43) Pub. Date: Aug. 6, 2026

(54) METHOD FOR PRODUCING PHOTONIC DEVICE, AND PHOTONIC DEVICE

(71) Applicants: UNIVERSITY PUBLIC CORPORATION OSAKA, Osaka (JP); KYOTO UNIVERSITY, Kyoto (JP)

(72) Inventors: Yasushi TAKAHASHI, Osaka (JP); Yuji OTA, Osaka (JP); Shunsuke IKUTA, Osaka (JP); Susumu NODA, Kyoto (JP); Takashi ASANO, Kyoto (JP); Makoto OKANO, Ibaraki (JP)

(21) Appl. No.: 19/159,157

(22) PCT Filed: Feb. 16, 2024
(86) PCT No.: PCT/JP2024/005538

§ 371 Date: Aug. 22, 2025

(30) Foreign Application Priority Data
Feb. 24, 2023 (JP) 2023-027733

(51) Int. Cl. G02B 6/136; G02B 6/122

(52) U.S. Cl. CPC G02B 6/136; G02B 6/122

(57) ABSTRACT

This invention reduces internal absorption of a photonic device. A method, in accordance with the present disclosure, for producing a photonic device carries out: a first step (step S30) of processing silicon (1) by dry etching to obtain a specific shape (4); and a second step (step S50) of removing a surface layer (4a) of the specific shape (4) by chemical etching or thermal etching.

### TECHNICAL FIELD

The present disclosure relates to (i) a method for producing a photonic device and (ii) a photonic device.

### BACKGROUND ART

Patent Literature 1 and Non-Patent Literature 1 are related to a silicon photonic crystal provided with an optical waveguide and an optical resonator.

### CITATION LIST

### Patent Literatures

### Patent Literature 1

Japanese Patent Application Publication, Tokukai, No. 2019-40046 (published on March 14, 2019)

### Non-Patent Literatures

“Raman silicon laser based on a nanocavity fabricated by photolithography” Vol. 3, No. 4/15 Apr. 2020/OSA Continuum 814-823

### SUMMARY OF INVENTION

### Technical Problem

The conventional techniques have room for improvement in terms of internal absorption of a photonic device obtained by processing silicon or a silicon compound.

### Solution to Problem

A method, in accordance with an aspect of the present disclosure, for producing a photonic device includes: a first step of processing silicon or a silicon compound by dry etching to obtain a specific shape; and a second step of removing a surface layer of the specific shape by chemical etching or thermal etching.

A photonic device in accordance with an aspect of the present disclosure includes: a specific shape obtained by processing silicon or a silicon compound by dry etching, a surface layer extending up to 10 nm from a surface of the specific shape not containing a substance that increases light absorption of the photonic device.

A photonic device in accordance with an aspect of the present disclosure includes: a specific shape obtained by processing silicon or a silicon compound by dry etching, the photonic device not having a surface layer extending up to 10 nm from a surface of the specific shape which is immediately after being subjected to the dry etching.

### Advantageous Effects of Invention

In accordance with an aspect of the present disclosure, it is possible to reduce internal absorption of a photonic device more than conventional techniques. Specifically, an aspect of the present disclosure is expected to increase an experimental quality (Q) factor of a resonator from 20,000 to 200,000.

### BRIEF DESCRIPTION OF DRAWINGS

FIG. 1 is a cross-sectional view illustrating an example of a method for producing a photonic device in accordance with an aspect of the present disclosure.

FIG. 2 is a plan view illustrating an example of the method for producing the photonic device illustrated in FIG. 1.

FIG. 3 is a plan view illustrating another example of the method for producing the photonic device illustrated in FIG. 1.

FIG. 4 is a cross-sectional view illustrating another example of the method for producing the photonic device illustrated in FIG. 1.

FIG. 5 is a plan view illustrating a configuration of a photonic device in accordance with an experimental example of the present disclosure.

FIG. 6 is an energy diagram illustrating a photonic band structure of a heterostructure resonator illustrated in FIG. 5.

FIG. 7 shows a SEM image of a surface of a sample not washed in accordance with an experimental example of the present disclosure.

FIG. 8 shows a SEM image of a surface of a sample washed 12 times in accordance with the experimental example of the present disclosure.

FIG. 9 shows a graph of Q-values of experimental examples of the present disclosure and a comparative example.

FIG. 10 is a perspective view illustrating an example of a configuration of a photonic device in accordance with an aspect of the present disclosure.

FIG. 11 is a cross-sectional view illustrating an example of a method for producing a photonic device in accordance with an aspect of the present disclosure.

### DESCRIPTION OF EMBODIMENTS

The present disclosure uses Miller indices to determine a crystal plane. Specifically, unit lattice vectors a₁, a₂, and a₃ and integers h, k, and l are used, and a crystal plane passing through three points designated by 1/h*vector a₁, 1/k*vector a₂, and 1/1×vector a₃ is referred to as a (hkl) plane. The (hkl) plane and a plane(s) equivalent to the (hkl) plane are collectively referred to as a (hkl) equivalent plane.

### First Embodiment

### Production Method

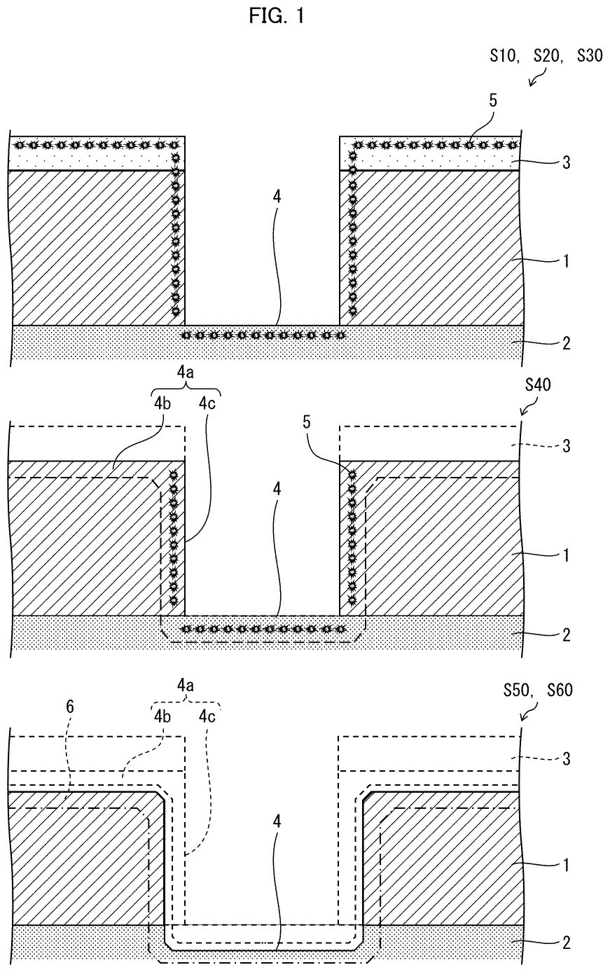

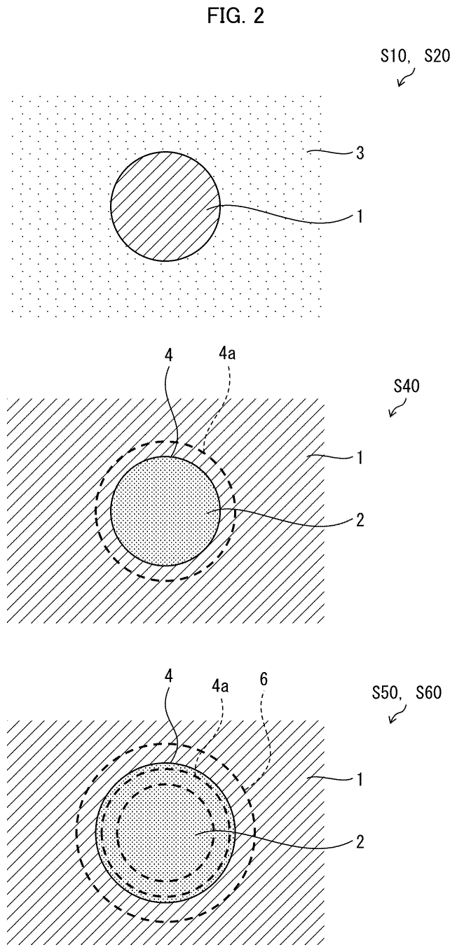

FIGS. 1 and 2 are respectively a cross-sectional view and a plan view illustrating an example of a method for producing a photonic device in accordance with an aspect of the present disclosure. As shown in FIGS. 1 and 2, first, silicon 1 or a silicon compound is prepared (step S10). The silicon compound includes, for example, silicon nitride, silicon oxide, or silicon oxynitride. In the example shown in FIG. 1, a top silicon layer made of a silicon on insulator (SOI) substrate is prepared as the silicon 1. In the present disclosure, the silicon and the top silicon layer are given the same reference sign “1”. The SOI substrate includes: a silicon support substrate; an embedded silica layer 2 on the silicon support substrate; the top silicon layer 1 on the embedded silica layer 2.

Subsequently, a mask layer 3 is formed on the silicon 1 or the silicon compound, and the mask layer 3 is patterned by using a photolithography technology, an electron beam lithography technology, a nanoimprinting technology, or the like (step S20). Then, the silicon 1 or the silicon compound is processed by dry etching, so that a specific shape 4 is obtained (step S30, “first step”). The dry etching includes, for example, plasma etching. The specific shape 4 includes, for example, at least one selected from the group consisting of a plurality of pores in a photonic crystal, an optical waveguide, and an optical ring resonator. Examples of the optical waveguide include a silicon thin-wire, a silicon compound thin-wire, a rib type waveguide, and all other optical waveguides. In the example illustrated in FIG. 1, the specific shape 4 is a plurality of pores. In the present disclosure, the specific shape and the plurality of pores are given the same reference sign “4”. As a result of the dry etching, substances 5 (so-called “impurities” or “surface layer impurities”) are given to the specific shape 4. Such substances 5 typically increase light absorption of the photonic device. The expression “the substances 5 are given to the specific shape 4” means that, in a case where the specific shape 4 is the pores 4, the substances 5 are given to a portion of the silicon 1 or the silicon compound which portion remains after formation of the pores 4. When the present disclosure is understood by replacing the “specific shape 4” with the “pores 4”, the “specific shape 4” should be replaced with “the portion of the silicon 1 or the silicon compound which portion remains after formation of the pores 4”.

The substances 5 that increase the light absorption include, for example, a substance used as an etching gas with respect to the silicon 1 or the silicon compound and a gas which is to be added to the etching gas. Examples of such a substance include fluorine, sulfur, boron, chlorine, bromine, iodine, oxygen, hydrogen, carbon, argon, helium, and xenon. The substances 5 may include a plurality of kinds of substances. In this case, a concentration of the substances 5 is a sum total of concentrations of the plurality of kinds of substances.

Subsequently, the mask layer 3 is removed (step S40), and a surface layer 4a of the specific shape 4 is removed by chemical etching or thermal etching (step S50, “second step”). The chemical etching or thermal etching in step S50 is a technology for removing the surface layer 4a at nanometer scale. If necessary, step S50 is repeated so that the surface layer 4a is removed up to a desired depth. The substances 5 given to the specific shape 4 as a result of dry etching in step S30 can be at least partially removed by chemical etching or thermal etching conducted in step S50. It should be noted that, in the present disclosure, the “surface” and the “surface layer” should be distinguished from each other. The “surface” does not have a depth (i.e., a thickness). Meanwhile, the “surface layer” is a layer having a depth of a given distance from the surface.

In step S50, the surface layer 4a may be oxidized, and the resulting oxide film may be removed by chemical etching. Oxidation of the surface layer 4a may be carried out by a method other than a heating process of heating the specific shape 4 itself. Heating the subject itself is carried out for the purpose of cleaning a surface of the subject or reducing a defect on the surface. The method for oxidizing the surface layer 4a includes, for example, a method involving use of a high-temperature and high-humidity oxygen atmosphere and a method involving use of a solution that causes oxidation at room temperature. Examples of such a solution include a sulfuric acid-hydrogen peroxide mixture (SPM). The oxide film may be removed by washing with use of any one selected from the group consisting of a diluted hydrofluoric acid, a phosphoric acid solution, a nitric acid solution, and the like. A method constituted by a combination of (i) oxidation with a high-temperature oxygen atmosphere and (ii) removal of the oxide film using chemical etching is referred to as “thermal etching”. Alternatively, in step S50, the surface layer 4a may be removed directly by chemical etching, without oxidizing the surface layer 4a. Use of an alkaline solution such as a dilute potassium hydroxide solution makes it possible to carry out wet etching on the silicon with nanometer-level accuracy at room temperature, even without oxidation. It should be noted that a heating process of heating the SOI substrate or the specific shape 4 is not carried out between step S30 and step S50. It should be also noted that the heating process herein is different from an exposure process of exposing a subject to a high-temperature atmosphere.

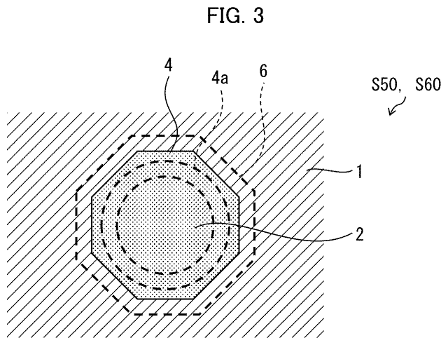

FIG. 3 is a plan view illustrating another example of the method for producing the photonic device illustrated in FIG. 1. As shown in FIG. 3, the specific shape 4 is a plurality of pores 4 in a photonic crystal. In a case where an opening of each of the pores 4 is formed into a circular shape by dry etching, the opening of each of the pores 4 can be expanded into an octagonal shape by chemical etching or thermal etching. This is not limitative. The specific shape 4 may be deformed by chemical etching or thermal etching. The deformation may depend on the crystal structure or the plane direction of the silicon 1 or the silicon compound.

The silicon has (111) equivalent planes which serve as difficult-to-etch planes against many etching solutions and thermal etching. Thus, by chemical etching or thermal etching conducted after dry etching, the opening shapes of the pores 4 are apt to be deformed such that sides of the opening shapes of the pores 4 are extended along the (111) equivalent planes. The (111) equivalent planes of the silicon include eight planes, that is, a (111) plane, a (−111) plane, a (1−11) plane, a (−1−11) plane, a (11−1) plane, a (−11−1) plane, a (1−1−1) plane, and a (1−1−1) plane. The above-described octagonal shape corresponds to a shape obtained as a result of carrying out chemical etching or thermal etching with respect to the circular opening obtained by the dry etching conducted at the beginning and accordingly giving, to the circular opening, four sides along the (111) plane, the (−111) plane, the (1−11) plane, and the (−1−11) plane among the difficult-to-etch planes. When the etching is further carried out, the four adjacent difficult-to-etch planes cross each other and four sides intersect each other, whereby the opening of the pore 4 may be formed into a quadrangular shape. Depending on the opening shape given by the dry etching conducted at the beginning, the opening shape can be deformed in more various ways when subjected to chemical etching or thermal etching conducted thereafter. Any of the opening shapes of the pore 4 is likely to be an opening shape including at least one side extending along any one of the four planes, that is, the (111) plane, the (−111) plane, the (1−11) plane, and the (−1−11) plane. In substrates having other plane directions, such as a (110) silicon substrate, and substrates having an off-plane, it is also possible to obtain pores having a shape based on a similar mechanism. An etching solution that increases an etching rate on a difficult-to-etch plane more than those of other surfaces is commercially available. Use of such an etching solution can provide pores having a shape based on a similar mechanism.

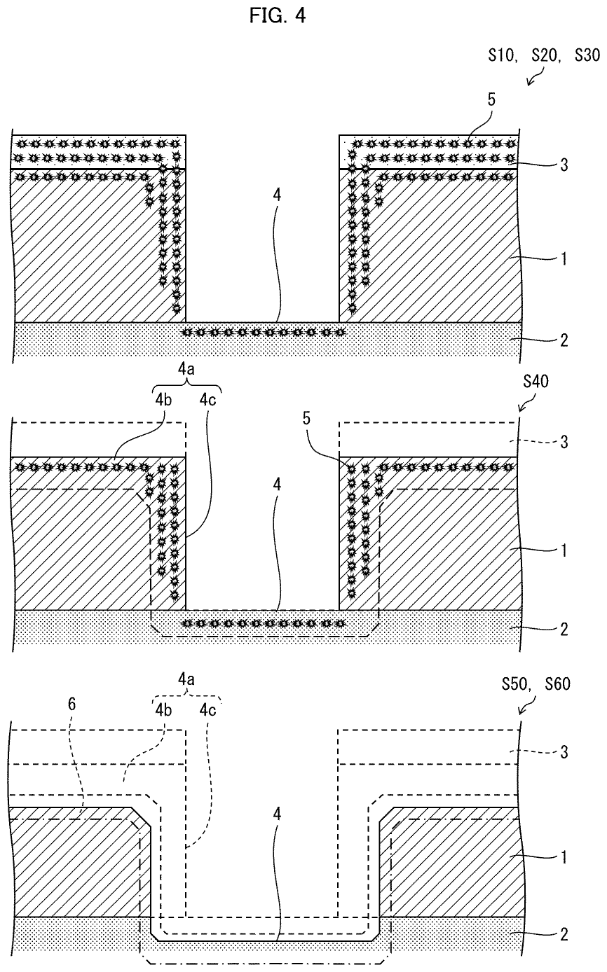

FIG. 4 is a cross-sectional view illustrating another example of the method for producing the photonic device illustrated in FIG. 1. As illustrated in FIG. 4, the substances 5 may be distributed such that, with increasing proximity to an upper surface (upward in FIG. 4), more substances 5 exist or a thickness of a layer including substances 5 increases. Further, chemical etching or thermal etching is carried out such that the substances 5 are adequately removed in an area close to the upper surface.

Subsequently, referring back to FIGS. 1 and 2, the specific shape 4 is washed with pure water (step S60). If necessary, step S50 and step S60 are repeated.

With the production method in accordance with the present disclosure, it is possible to remove the surface layer 4a to which the substances 5 are given, thereby yielding the specific shape 4 having a fresh surface layer 6. Thus, with the production method in accordance with the present disclosure, it is possible to reduce the internal absorption of the photonic device by removing the surface layer impurities from the specific shape 4. The reduction of the internal absorption makes it possible to increase an effective Q-value of the optical resonator and to reduce a propagation loss of the optical waveguide.

### Configuration

A photonic device in accordance with the present disclosure is a photonic device produced by the production method in accordance with the present disclosure. With the production method in accordance with the present disclosure, it is possible to form a photonic crystal, an optical waveguide, and an optical ring resonator in each of which surface layer impurities are reduced. Note that it is impractical to directly specify them by structure or by characteristics.

There have been known, as a method for measuring a composition or impurities of a substance, absorption spectrophotometry, Energy dispersive X-ray spectroscopy (EDX), cathodoluminescence, Secondary ion mass spectrometry (SIMS), and the like. With these measurement methods, however, it is impossible to limit a measurement range to (i) a surface layer of a wall surface of a pore having a diameter of several hundred nanometers or (ii) a surface layer of a side surface of an optical waveguide or an optical resonator, since the wall surface(s) and the side surface(s) of these fine structures are not flat. Combining the measurement of impurities by any of these measurement methods and checking of the measurement range by a scanning electron microscope (SEM) may be considered. This, however, requires significant expense. In addition, it is difficult to carry out work on a very small side surface of the optical waveguide and/or the like. Thus, it is technically difficult to combine these device with high accuracy. For this reason, combining them is not impractical.

It is considered that the surface layer impurities are incorporated into the surface layer as a result of dry etching. By repeating (i) chemical etching of the surface layer and (ii) Q-value measurement after the chemical etching, the inventors of the present invention found that impurities (substances that increase the light absorption of the photonic device) embedded into the substrate by plasma etching exist in a depth from 5 nm to 10 nm measured from the surface, for example. Thus, by observing the surface of a sample, it is impossible to observe the surface layer impurities, and, as discussed above, it is impossible to measure a thickness of a layer in which the surface layer impurities exist.

It is beneficial to remove, by chemical etching or thermal etching in step S50, the surface layer 4a, particularly a surface layer 4c of a side wall, up to a depth with which the surface layer impurities are adequately removed. According to the above-described knowledge, the substances 5 embedded in the substrate by plasma etching exist in a depth range from 5 nm to 10 nm measured from the surface. When the removal of a depth range from not less than 5 nm to not more than 15 nm measured from the surface was experimentally conducted under this condition, a good result was obtained. Therefore, in a case where dry etching in step S30 is plasma etching, it is beneficial to carry out, by chemical etching or thermal etching in step S50, removal up to a depth range from not less than 5 nm to not more than 15 nm measured from the surface of the specific shape 4 is carried out. It is also beneficial to carry out removal up to a depth range from not less than 5 nm to not more than 10 nm measured from the surface of the specific shape 4.

It should be noted that a depth range suitable for the removal in step S50 can be modified in various ways in accordance with the condition under which step S30 is carried out and the design specification of the specific shape 4. For example, it is expected that the layer thickness in which the surface layer impurities exist can be reduced by changing or improving the kind, the condition, and/or the like of dry etching. In a case where the layer thickness is small as above, it is beneficial to carry out removal up to a depth range of not less than several nanometers measured from the surface. A lower limit value of the depth range suitable for removal may be 2 nm or 3 nm. Meanwhile, for example, with a design specification according to which a thickness for the specific shape 4 is large or a design specification according to which the pores 4 have a deep depth, it is expected that a layer thickness in which surface layer impurities, introduced by dry etching, exist is large. This includes such a case that an amount of surface layer impurities increases with increasing proximity to the upper surface, as shown in FIG. 4. In a case where the layer thickness is large as above, it is beneficial to carry out removal up to a depth range of not more than several tens nanometers measured from the surface. An upper limit value of the depth range suitable for removal may be 20 nm or 30 nm.

The depth to be removed by chemical etching or thermal etching (hereinafter, such a depth will be referred to as an “etching depth”) can have an error depending on the location. Measurement of the etching depth can have an error. It is beneficial to determine the etching depth while taking into consideration of such an error.

The etching depth can be measured by various methods. For example, in a case where an etching rate is known, a product of the etching rate and a period of time for chemical etching may be calculated as an etching depth in some cases. For example, in a plan view, an opening radius of the pore in the photonic crystal or a wire width of the optical waveguide or the optical ring resonator can be measured before and after chemical etching, and a half value of a difference between the opening radiuses or a difference between the wire widths may be calculated as an etching depth in some cases. The opening radius refers to a radius of a circle having the same area as that of the opening which is to be measured. Opening areas of two or more openings may be calculated and an average value of the resulting values may be calculated.

As discussed above, chemical etching or thermal etching may sometimes deform the specific shape 4 depending on the crystal structure of the silicon 1 or the silicon compound. It is beneficial to determine the etching depth while taking it consideration of such deformation. For example, in a case where the shape of the opening of each of the pores 4 is expanded evenly from a circular shape to a regular octagonal shape, it is beneficial to determine a distance from a center of a side of the regular octagonal shape to the circular shape is adapted to a depth that enables adequate removal of the surface layer impurities.

A photonic device in accordance with the present disclosure is a photonic device which includes the specific shape 4 obtained by processing the silicon or the silicon compound by dry etching, the surface layer 6 extending up to 10 nm from the surface of the specific shape 4 not containing substances 5 that increase light absorption of the photonic device. It should be noted that, in the present disclosure, the surface layer 4a which is immediately after being subjected to dry etching (i.e., before being subjected to chemical etching or thermal etching) and the surface layer 6 which is after being subjected to chemical etching or thermal etching are distinguished from each other.

When a concentration of the substances 5 in the surface layer 6 is estimated and the resulting estimation value is less than 10¹⁶(/cm³ ), preferably less than 10¹⁵(/cm³ ), it can be considered that the surface layer 6 does not substantially contain the substances 5. Depending on the method for producing the photonic device and/or the configuration of the resulting photonic device, a concentration measurement area in which a surface layer concentration of the substances 5 can be measured may sometimes be naturally generated in the photonic device. Further, in production of the photonic device, another member having a concentration measurement area can be formed on the same substrate. In the concentration measurement area, concentrations of respective substances contained in the surface layer can be measured by absorption spectrophotometry, Energy dispersive X-ray spectroscopy (EDX), cathode luminescence, Secondary ion mass spectrometry (SIMS), or the like. On the basis of the measurement of the surface layer concentration in the concentration measurement area, it is possible to estimate a surface layer concentration in the specific shape 4. The configuration that does not substantially contain the substances 5, which increase the light absorption, is effective for any optical resonator, such as a heterostructure resonator or a ring resonator, and for any optical waveguide such as a silicon thin-wire waveguide, a silicon compound thin-wire waveguide, a rib type waveguide, or a heterostructure waveguide.

A photonic device in accordance with the present disclosure is a photonic device that includes the specific shape 4 obtained by processing the silicon or the silicon compound by dry etching, the surface layer 4a extending up to 10 nm from the surface of the specific shape 4 which is immediately after being subjected to the dry etching having been removed.

The above-discussed specific shape 4 may be the plurality of pores 4 in the photonic crystal, and the opening of each of the pores 4 may have a circular shape. Alternatively, the opening of each of the pores 4 may have an octagonal shape.

### Experimental Example 1

In production of a photonic device 10 in accordance with an experimental example 1 of the present disclosure, a top silicon layer 1 of an SOI substrate was processed by plasma etching, whereby a plurality of pores 4 were formed in a photonic crystal (step S30, “first step”). Subsequently, a mask layer 3 was removed (step S40), and washing with SPM and a diluted hydrofluoric acid was carried out one or more times, so as to remove a surface layer 4b on an upper surface of a remaining portion of the top silicon layer 1 and a surface layer 4c on side walls of the plurality of pores 4 (step S50, “second step”). Hereinafter, in the present disclosure, a photonic device which has not been washed with SPM yet will be referred to as a “sample not washed”. Meanwhile, a photonic device which has been washed with SPM and a diluted hydrofluoric acid n times will be referred to as a “sample washed n times”. Note that n is a natural number. Note that the diluted hydrofluoric acid may be replaced with another solution, such as a phosphoric acid solution or a nitric acid solution.

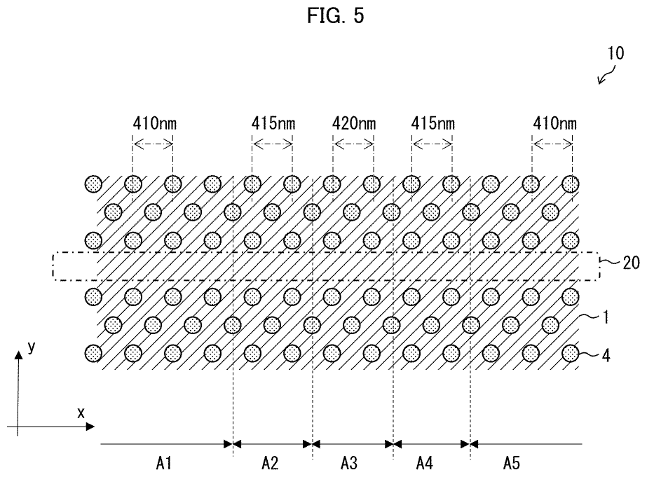

FIG. 5 is a plan view illustrating a configuration of a photonic device in accordance with an experimental example. As illustrated in FIG. 5, a photonic device 10 in accordance with the experimental example 1 included: silicon 1 including a two-dimensional photonic crystal in which a plurality of pores 4 were formed regularly; and a defect area which extended in a straight line along an x-direction, which included no pore 4 formed therein, and which served as a heterostructure resonator 20. The photonic device 10 included a first area A1, a second area A2, a third area A3, a fourth area A4, and a fifth area A5, which were aligned in this order along the x-direction. A center-to-center distance of the pores 4 was designed at 410 nm in the first area A1 and the fifth area A5, at 415 nm in the second area A2 and the fourth area A4, and at 420 nm in the third area A3. A radius of the pores 4 in the sample not washed with SPM was designed at 122 nm.

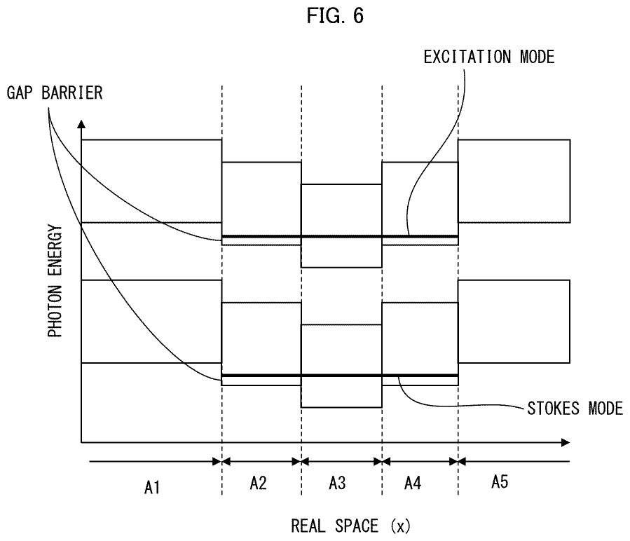

FIG. 6 is an energy diagram illustrating a photonic band structure in the heterostructure resonator illustrated in FIG. 5. As illustrated in FIG. 6, a gap barrier was generated between the areas in accordance with the difference in the center-to-center distance of the pores 4, so that two nano-resonator modes (excitation mode and Stokes mode) were formed. In each of the sample washed two times, the sample washed three times, the sample washed six times, the sample washed nine times, and the sample washed 12 times in accordance with the experimental example 1, an experimental Q-value in excitation mode was calculated.

A radius of the pores 4 in each sample was calculated on the basis of an image captured by a scanning electron microscope (SEM). Specifically, in each of the samples, areas of openings of three pores 4 in the SEM image were measured, and radiuses of circles having the same areas as those of the respective openings were calculated. Then, an average of these radiuses was obtained as the radius of the pores 4.

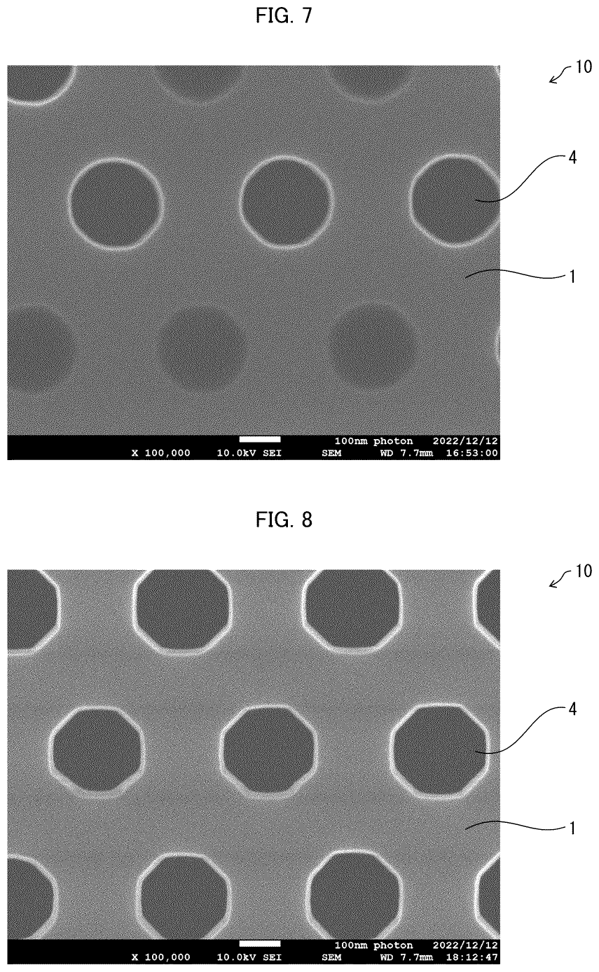

FIG. 7 shows a SEM image of a surface of the sample not washed in accordance with the experimental example 1. FIG. 8 shows a SEM image of a surface of the sample washed 12 times in accordance with the experimental example 1. As shown in FIGS. 7 and 8, the opening of each of the pores 4 in the sample not washed had a substantially circular shape, whereas the opening of each of the pores 4 in the sample washed 12 times had a substantially octagonal shape. Further, a difference between the radius of the pores 4 in the sample not washed and the radius of the pores 4 in the sample washed 12 times was approximately 10 nm.

By the same procedures as those for the photonic device in accordance with the experimental example 1, photonic device in accordance with experimental examples 2 to 7 were produced on the substrate on which the photonic device in accordance with the experimental example 1 was formed. Thus, the production accuracies of the experimental examples 2 to 7 were equal to that of the experimental example 1. The photonic devices in accordance with the experimental examples 2 to 7 were designed so as to be identical in configuration to the photonic device 10 in accordance with the experimental example 1, except for the radius of the pores 4. The radiuses of the pores 4 in the experimental examples 2 to 7 were designed such that the radiuses of the pores 4 in the samples not washed in the experimental examples 2 to 7 increased in stages in a range of 125 nm to 132 nm.

In each of the sample washed two times, the sample washed three times, the sample washed six times, the sample washed nine times, and the sample washed 12 times in accordance with the experimental examples 2 to 7, an experimental Q-value in excitation mode was calculated. Further, the radius of the pores 4 in each of these samples was calculated on the basis of a SEM image.

### Comparative Example 1

Various photonic crystals each including (i) pores 4 whose radius was in a range of 125 nm to 132 nm and (ii) a heterostructure resonator were virtually designed. Then, design Q-values of excitation light obtained when beams of excitation light of various wavelengths were emitted to the resonator were calculated, without taking into consideration of internal absorption.

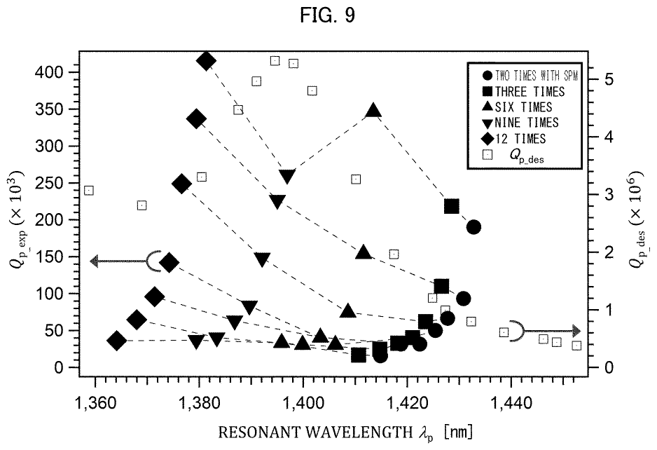

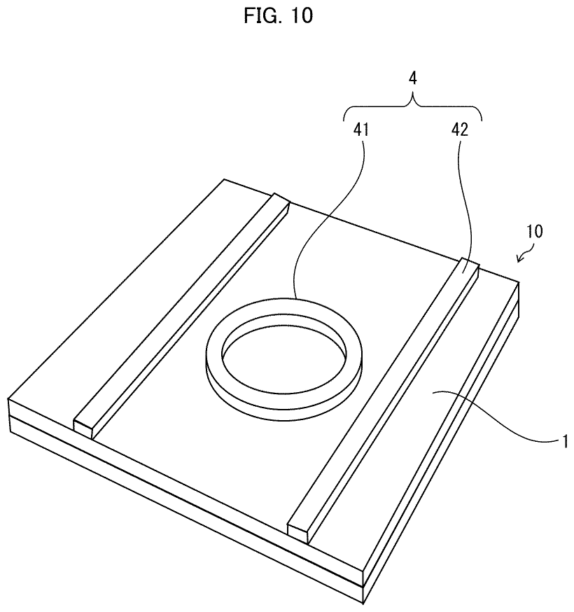

FIG. 9 shows a graph of Q-values of the experimental examples 1 to 7 and the comparative example 1. In FIG. 9, the vertical axis on the left side indicates an experimental Q-value (Q_{p_exp}), and each of the numerical values on the scales are read by multiplying the numerical value by 10 to a third power. In FIG. 9, the vertical axis on the right side indicates a design Q-value (Q_{p_des}) measured in a case where the pores 4 had a circular shape, and each of the numerical values on the scales are read by multiplying the numerical value by 10 to a sixth power. In FIG. 9, the horizontal axis is common to the experimental Q-value and the design Q-value, and indicates a resonant wavelength (λₚ).

The points related to the samples of the experimental examples 1 to 7 are indicated by black filled symbols, whereas the points related to the comparative example 1 are indicated by while outline symbols. In relation to the examples 1 to 7, the points related to the samples washed two times are indicated by circles, the points related to the samples washed three times are indicated by squares, the points related to the samples washed six times are indicated by upward triangles, the points related to the samples washed nine times are indicated by downward triangles, and the points related to the samples washed 12 times are indicated by diamond shapes.

As shown in FIG. 9, comparison between the samples washed with the same times shows that a sample with pores 4 having a larger radius had a shorter resonant wavelength and a smaller experimental Q-value. Since the production accuracies of the experimental examples 1 to 7 were equal to each other, it is assumed that the wavelength dependency of the experimental Q-value was caused by an absorption loss inside the sample.

Comparison between the samples in the same experimental example shows that a sample washed more times, in other words, a sample with pores 4 having a larger radius had a tendency to exhibit a shorter resonant wavelength and a larger experimental Q-value.

Comparison between the samples with the same resonant wavelength or similar resonant wavelengths shows that a sample washed more times had a tendency to exhibit a larger experimental Q-value than that of a sample washed less times. To be more specific, the experimental Q-value was not improved so much in the samples washed two or less times, whereas the experimental Q-value was significantly improved in the samples washed with three times, six times, nine times, and 12 times. From FIGS. 6 and 7, it is clear that repetition of washing caused the shapes of the pores 4 to be deviated from the design. On the other hand, repetition of washing removed the surface layer impurities causing the absorption loss. Although the design Q-value was caused by the deviation, an effectiveness more than offsetting this drawback was achieved by the removal of the surface layer impurities; therefore, the experimental Q-value was improved. In some experimental examples, washing was carried out 13 or more times. This, however, resulted in formation of the pores 4 whose shapes were far larger than the design. Thus, it was impossible to determine whether or not the experimental Q-value was improved.

### Second Embodiment

For convenience, members having functions identical to those of the respective members of the foregoing first embodiment are given respective identical reference numerals, and a description of those members is omitted.

FIG. 10 is a perspective view illustrating an example of a configuration of a photonic device in accordance with an aspect of the present disclosure. As illustrated in FIG. 10, a specific shape 4 may include a ring resonator 41. In addition to this or instead of this, the specific shape may include a thin-wire waveguide 42. The thin-wire waveguide 42 is a silicon thin-wire or a silicon compound thin-wire. The ring resonator 41 and the thin-wire waveguide 42 are given as embossed parts of silicon 1 or a silicon compound, obtained as a result of dry etching, and a surface layer thereof are removed by chemical etching or thermal etching.

The specific shape 4 is not limited to this, and may include at least one type of optical waveguide selected from the group consisting of a silicon thin-wire waveguide, a silicon compound thin-wire waveguide, a rib type waveguide, and a heterostructure waveguide. In the present disclosure, the embossed parts of the silicon compound such as those illustrated in FIG. 10 may be referred to as the specific shape 4 in some cases, or the carved parts in the silicon compounds such as those illustrated in FIGS. 1 to 5 may be referred to as the specific shapes 4 in other cases. In either case, as illustrated in FIGS. 1 and 4, the substances 5 are more likely to intrude into the surface layer 4c on the side surface than into the surface layer 4b on the upper surface. Therefore, regardless of whether the specific shape 4 is the embossed part or the carved part, a depth for removing the surface layer 4a of the specific shape 4 varies depending on the depth of the surface layer 4c on the side surface in which depth the substances 5 intrude.

### Third Embodiment

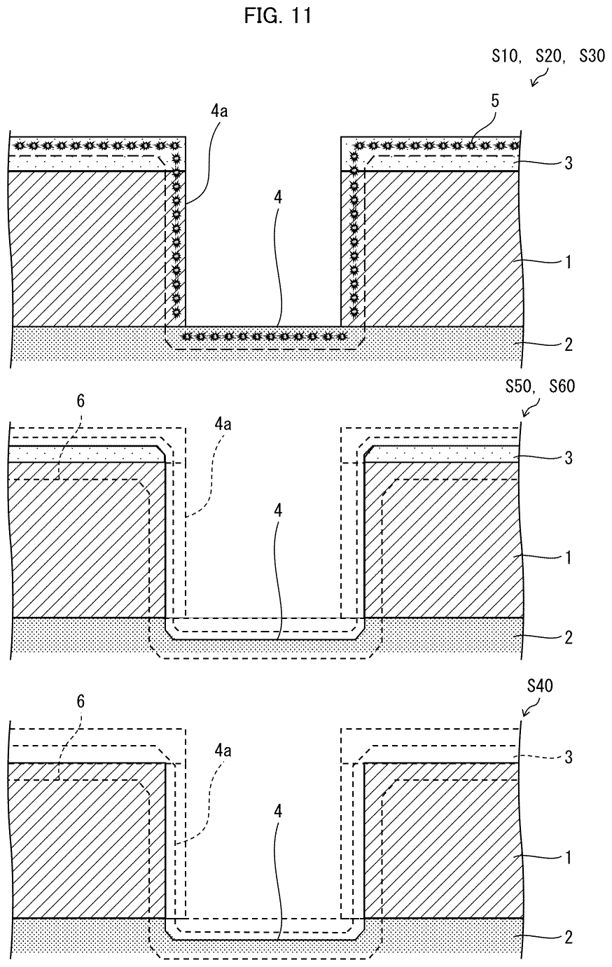

FIG. 11 is a cross-sectional view illustrating an example of a method for producing a photonic device in accordance with an aspect of the present disclosure. As illustrated in FIG. 11, step S40 may be carried out after step S50.

The present disclosure is not limited to the above-described embodiments, but can be altered by a skilled person in the art within the scope of the claims. The present disclosure also encompasses, in its technical scope of the present disclosure, any embodiment derived by combining technical means disclosed in differing embodiments. The specific shape in accordance with the present disclosure can encompass a pore(s), an optical resonator such as a heterostructure resonator or a ring resonator, an optical waveguide such as a thin-wire waveguide, a rib type waveguide, or a heterostructure waveguide, and any shape which can express an optical feature.

Aspects of the present invention can also be expressed as follows:

A method, in accordance with a first aspect of the present disclosure, for producing a photonic device includes: a first step of processing silicon or a silicon compound by dry etching to obtain a specific shape; and a second step of removing a surface layer of the specific shape by chemical etching or thermal etching.

A method, in accordance with a second aspect of the present disclosure, for producing a photonic device may be the production method described in the first aspect configured such that: at least part of a substance given to the specific shape by the dry etching is removed by the chemical etching or the thermal etching.

A method, in accordance with a third aspect of the present disclosure, for producing a photonic device may be the production method described in the first or second aspect configured such that: the dry etching is plasma etching; and a part extending up to a depth of not less than 2 nm and not more than 30 nm from a surface of the specific shape is removed by the chemical etching or the thermal etching.

A method, in accordance with a fourth aspect of the present disclosure, for producing a photonic device may be the production method described in any one of the first to third aspects configured such that: the dry etching is plasma etching; and a part extending up to a depth of not less than 5 nm and not more than 15 nm from a surface of the specific shape is removed by the chemical etching or the thermal etching.

A method, in accordance with a fifth aspect of the present disclosure, for producing a photonic device may be the production method described in any one of the first to fourth aspects configured such that: the dry etching is plasma etching; and a part extends up to a depth of not less than 5 nm and not more than 10 nm from a surface of the specific shape is removed by the chemical etching or the thermal etching.

A method, in accordance with a sixth aspect of the present disclosure, for producing a photonic device may be the production method described in any one of the first to fifth aspects configured such that: a heating process of heating the specific shape is not carried out between the first step and the second step.

A method, in accordance with a seventh aspect of the present disclosure, for producing a photonic device may be the production method described in any one of the first to sixth aspects configured such that: the specific shape is a plurality of pores in a photonic crystal; the dry etching is plasma etching; the chemical etching is washing with any one selected from the group consisting of a diluted hydrofluoric acid, a phosphoric acid solution, and a nitric acid solution; the plurality of pores are formed by the plasma etching; and a surface layer on a side wall of each of the plurality of pores is removed by the washing.

A method, in accordance with an eighth aspect of the present disclosure, for producing a photonic device may be the production method described in any one of the first to seventh aspects configured such that: the specific shape is a plurality of pores in a photonic crystal; an opening of each of the plurality of pores is formed into a circular shape by the dry etching; and the opening of each of the plurality of pore is expanded to have an octagonal shape by the chemical etching or the thermal etching.

A method, in accordance with a ninth aspect of the present disclosure, for producing a photonic device may be the production method described in any one of the first to eighth aspects configured such that: the specific shape is a plurality of pores in a photonic crystal; and the plurality of pores are formed regularly so as to provide a defect area which extends in a straight line and which has no pore.

A method, in accordance with a tenth aspect of the present disclosure, for producing a photonic device may be the production method described in any one of the first to sixth aspects configured such that: the specific shape is a ring resonator.

A method, in accordance with an eleventh aspect of the present disclosure, for producing a photonic device may be the production method described in any one of the first to sixth aspects configured such that: the specific shape includes at least one type of optical waveguide selected from the group consisting of a silicon thin-wire waveguide, a silicon compound thin-wire waveguide, a rib type waveguide, and a heterostructure waveguide.

A photonic device in accordance with a twelfth aspect of the present disclosure includes: a specific shape obtained by processing silicon or a silicon compound by dry etching, a surface layer extending up to 10 nm from a surface of the specific shape not containing a substance that increases light absorption of the photonic device.

A photonic device in accordance with a thirteenth aspect of the present disclosure includes: a specific shape obtained by processing silicon or a silicon compound by dry etching, the photonic device not having a surface layer extending up to 10 nm from a surface of the specific shape which is immediately after being subjected to the dry etching.

A photonic device in accordance with a fourteenth aspect of the present disclosure has the configuration described in the twelfth aspect or the thirteenth aspect configured such that: the specific shape is a plurality of pores in a photonic crystal; and an opening of each of the plurality of pores has a circular shape.

A photonic device in accordance with a fifteenth aspect of the present disclosure has the configuration described in the twelfth aspect or the thirteenth aspect configured such that: the specific shape is a plurality of pores in a photonic crystal; and an opening of each of the plurality of pores has an octagonal shape.

A photonic device in accordance with a sixteenth aspect of the present disclosure has the configuration described in the twelfth aspect or the thirteenth aspect configured such that: the specific shape is a plurality of pores in a photonic crystal; and an opening of each of the plurality of pores has a quadrangular shape.

A photonic device in accordance with a seventeenth aspect of the present disclosure has the configuration described in the twelfth aspect or the thirteenth aspect configured such that: the specific shape is a plurality of pores in a photonic crystal; and an opening of each of the plurality of pores has a shape having at least one side extending along any one selected from the group consisting of four planes: a (111) plane; a (−111) plane; a (1−11) plane; and a (−1−11) plane.

A photonic device in accordance with an eighteenth aspect of the present disclosure has the configuration described in any one of the twelfth to seventeenth aspects configured such that: the specific shape is a plurality of pores in a photonic crystal; the plurality of pores are formed regularly; and the photonic crystal comprises a defect area which extends in a straight line and which has no pore.

A photonic device in accordance with a nineteenth aspect of the present disclosure has the configuration described in the twelfth aspect or the thirteenth aspect configured such that: the specific shape is a ring resonator.

A photonic device in accordance with a twentieth aspect of the present disclosure has the configuration described in the twelfth aspect or the thirteenth aspect configured such that: the specific shape includes at least one type of optical waveguide selected from the group consisting of a silicon thin-wire waveguide, a silicon compound thin-wire waveguide, a rib type waveguide, and a heterostructure waveguide.

### REFERENCE SIGNS LIST

1: silicon, top silicon layer
4: specific shape, pore
4a: surface layer (which is immediately after being subjected to dry etching)
4c: surface layer of side wall
5: substance
6: surface layer
10: photonic device
41: ring resonator
42: thin-wire waveguide

1. A method for producing a photonic device, comprising:
a first step of processing silicon or a silicon compound by dry etching to obtain a specific shape; and
a second step of removing a surface layer of the specific shape by chemical etching or thermal etching such that a part extending up to a depth of not less than 2 nm and not more than 30 nm from a surface of the specific shape is removed.

2. The method according to claim 1, wherein:
at least part of a substance given to the specific shape by the dry etching is removed by the chemical etching.

3. The method according to claim 1, wherein:
the dry etching is plasma etching.

4. The method according to claim 1, wherein:
the dry etching is plasma etching; and
a part extending up to a depth of not less than 5 nm and not more than 15 nm from a surface of the specific shape is removed by the chemical etching.

5. The method according to claim 1, wherein:
the dry etching is plasma etching; and
a part extending up to a depth of not less than 5 nm and not more than 10 nm from a surface of the specific shape is removed by the chemical etching.

6. The method according to claim 1, wherein:
a heating process of heating the specific shape is not carried out between the first step and the second step.

7. The method according to claim 1, wherein:
the specific shape is a plurality of pores in a photonic crystal;
the dry etching is plasma etching;
the chemical etching is washing with any one selected from the group consisting of a diluted hydrofluoric acid, a phosphoric acid solution, and a nitric acid solution;
the plurality of pores are formed by the plasma etching; and
a surface layer on a side wall of each of the plurality of pores is removed by the washing.

8. A method for producing a photonic device, comprising:
a first step of processing silicon or a silicon compound by dry etching to obtain a specific shape; and
a second step of removing a surface layer of the specific shape by chemical etching or thermal etching,
the specific shape being a plurality of pores in a photonic crystal,
an opening of each of the plurality of pores being formed into a circular shape by the dry etching, and
the opening of each of the plurality of pore being expanded to have an octagonal shape by the chemical etching or the thermal etching.

9. The method according to claim 1, wherein:
the specific shape is a plurality of pores in a photonic crystal; and
the plurality of pores are formed regularly so as to provide a defect area which extends in a straight line and which has no pore.

10. The method according to claim 1, wherein:
the specific shape is a ring resonator.

11. The method according to claim 1, wherein:
the specific shape includes at least one type of optical waveguide selected from the group consisting of a silicon thin-wire waveguide, a silicon compound thin-wire waveguide, a rib type waveguide, and a heterostructure waveguide.

12. (canceled)

13. A photonic device comprising:
a specific shape obtained by processing silicon or a silicon compound by dry etching,
the photonic device not having a surface layer extending up to 10 nm from a surface of the specific shape which is immediately after being subjected to the dry etching.

14. The photonic device according to claim 13, wherein:
the specific shape is a plurality of pores in a photonic crystal; and
an opening of each of the plurality of pores has a circular shape.

15. The photonic device according to claim 13, wherein:
the specific shape is a plurality of pores in a photonic crystal; and
an opening of each of the plurality of pores has an octagonal shape.

16. The photonic device according to claim 13, wherein:
the specific shape is a plurality of pores in a photonic crystal; and
an opening of each of the plurality of pores has a quadrangular shape.

17. The photonic device according to claim 13, wherein:
the specific shape is a plurality of pores in a photonic crystal; and
an opening of each of the plurality of pores has a shape having at least one side extending along any one selected from the group consisting of four planes: a (111) plane; a (−111) plane; a (1−11) plane; and a (−1−11) plane.

18. The photonic device according to claim 13, wherein:
the specific shape is a plurality of pores in a photonic crystal;
the plurality of pores are formed regularly; and
the photonic crystal comprises a defect area which extends in a straight line and which has no pore.

19. The photonic device according to claim 13, wherein:
the specific shape is a ring resonator.

20. The photonic device according to claim 13, wherein:
the specific shape includes at least one type of optical waveguide selected from the group consisting of a silicon thin-wire waveguide, a silicon compound thin-wire waveguide, a rib type waveguide, and a heterostructure waveguide.

21. The method according to claim wherein:
the specific shape is a plurality of pores in a photonic crystal;
the dry etching is plasma etching;
the thermal etching is a method constituted by a combination of (i) oxidation with a high-temperature oxygen atmosphere and (ii) removal of an oxide film by washing with any one selected from the group consisting of a diluted hydrofluoric acid, a phosphoric acid solution, and a nitric acid solution;
the plurality of pores are formed by the plasma etching; and
a surface layer on a side wall of each of the plurality of pores is removed by the oxidation and the washing.
